(19) United States
(12) Patent Application Publication
(10) Pub. No.: US 2001/0015753 A1
(43) Pub. Date: Aug. 23, 2001

(54) Split image stereoscopic system and method

(76) Inventor: Kenneth J. Myers, Dobbs Ferry, NY (US)

Correspondence Address: BACON & THOMAS, PLLC, 4th Floor, 625 Slaters Lane, Alexandria, VA, 22314-1176, US

(21) Appl. No.: 09/729,079

(22) Filed: Dec. 5, 2000

Related U.S. Application Data
(63) Continuation-in-part of application No. 09/538,731, filed on Mar. 30, 2000.
Application No. 09/538,731 is a continuation-in-part of application No. 09/481,942, filed on Jan. 13, 2000.

(51) Int. Cl. H04N 15/00; H04N 13/04

(52) U.S. Cl. 348/51

(57) ABSTRACT

A system and method of stereoscopic imaging involves separating left and right eye images from a video input by electronically delaying alternate frames of the video input, and then cropping, scaling, and shifting the frame delayed images; simultaneously displaying the left and eye images on a screen; oppositely polarizing the simultaneously displayed left and right eye images; interlacing the oppositely polarized left and right eye images using a microprism sheet, a lenticular sheet, or a beam splitter, and viewing the oppositely polarized and interlaced left and right eye images through polarizing filters. In the case of a beam splitter, the image sources for displaying the left and right eye images are oriented at 90° relative to each other, and one of the left and right eye images is mirror symmetric relative to the other.

This application is a continuation-in-part of copending U.S. patent application Ser. No. 09/538,731, filed Apr. 27, 2000, which is a continuation-in-part of copending U.S. patent application Ser. No. 09/481,942, filed Jan. 14, 2000.

### BACKGROUND OF THE INVENTION

1. Field of the Invention

The invention relates to a system and method of stereoscopic imaging, and in particular to a system and method of stereoscopic imaging in which:

A. left and right eye images are separated from a video input by electronically delaying one frame in each successive pair of consecutive frames of the video input, and then cropping, scaling, and shifting at least the delayed frames in order to enable simultaneous display of the consecutive frames,

B. the left and eye images are simultaneously displayed on a screen,

C. the simultaneously displayed left and right eye images are oppositely polarized,

D. the oppositely polarized left and right eye images are interlaced by a microprism, lenticular sheet, or beam splitter, and

E. the oppositely polarized and interlaced left and right eye images are viewed through polarizing filters.

The invention also involves a system and method for creating a split image by alternately delaying, cropping, scaling, shifting, and interlacing left and right eye images.

Finally, the invention involves a system and method of arranging a split image so that it can conveniently be combined by a beam splitter to obtain a stereoscopic effect without requiring complex optics or shuttering.

2. Description of Related Art

a. Introduction

The present invention has in common with currently available stereoscopic systems the use of frame delay techniques to display multiple frames of a temporally interlaced image. However, the conventional frame delay involves compression of the images and scanning at twice the usual rate to eliminate the flicker caused by shuttering. Since the present invention requires no shuttering, but rather relies on passive optical multiplexing of simultaneously displayed images, the present invention does not require compression of the images and scanning at twice the usual rate. Instead, the present invention will work without modification at normal television scan rates, or at higher scan rates if desired.

In addition, the present invention involves the manner in which left and right eye images of the type created by the above-mentioned frame delay technique may be utilized to create a stereoscopic effect. As described in U.S. patent application Ser. No. 09/538,731, the left and right eye images are simultaneously displayed side-by-side, oppositely polarized, and then interlaced using a planar microprism or lenticular sheet, thereby eliminating the need for complex optical arrangements involving beam splitters, multiple lenses, mirrors, and the like. It turns out, however, that a single beam splitter can be used to combined the left and right eye images if the left and right eye images are appropriately arranged, and thus the system and method described in the parent application may be modified by replacing the microprism or lenticular sheet with a beam splitter.

A more detailed discussion of the prior art follows.

b. Basic Principles of Stereographic Imaging

The basic principles of stereoscopic imaging are well-known. Human vision is stereoscopic because each eye views the same scene from a different angle. The two separate images are combined by the brain to create a stereoscopic effect. In order to recreate the stereoscopic appearance of a scene on a flat screen, the scene must be captured by two cameras, one representing what a left eye would normally see, and one representing what a right eye would normally see. The left and right eye images are then interlaced so as to originate from the same location. A stereoscopic or three-dimensional image is obtained when each eye sees only the corresponding left and right eye portions of the interlaced image. The interlacing may be spatial or temporal in nature, with the present invention taking the unique approach of converting a time division multiplexed or temporally interlaced image into a spatially interlaced image that can easily be separated into discrete left and right eye images using polarization of the respective images.

c. Spatial Interfacing

There are two ways to optically modify the left and right eye portions of spatially interlaced images so that the left eye sees only the left eye portion of the interlaced image and the right eye sees only the right eye portion of the interlaced image. One way, illustrated in FIG. 1, is to color the left and right eye portions of the interlaced image 100 and to use color filters 101,102 to ensure that the left and right eyes see only the correspondingly colored portions of the interlaced image. The other way to modify the left and right eye images so that each eye will only see appropriate portions of the interlaced image is to polarize the left and right eye images in opposite directions, and to use oppositely polarized lenses to view the oppositely polarized portions of the interlaced image.

Polarization has significant advantages over color filtering in that it permits the stereoscopic image to be viewed in natural color without the loss of brightness caused by color filtering. Natural color is in general more pleasing to the viewer, while the increased brightness provided by polarization permits the use of lower intensity image sources such as LCD displays of the type used in portable handheld video game players.

In addition, polarization has the advantage that a person wearing polarized lenses can turn away from the interlaced image and view other objects or persons without having to take off the lenses. Since the polarizers and polarizing lenses have a substantially colorless appearance, the stereoscopic effect can be created with what appears to the viewer to be ordinary clear lenses, as opposed to the color lenses used in conventional non-polarizing stereoscopic systems.

Despite the well-known advantages of using polarizing filters to distinguish the left and right eye portions of interlaced stereoscopic images, it is currently impractical to use polarization in connection with conventional cathode ray tube or LCD displays because the light emitting pixels of the displays cannot be made to emit polarized light. As a result, unlike stereoscopic displays that use color, which can be colorized and interlaced before recording or broadcast, stereoscopic displays that use polarization require that polarization be carried out at the viewing location and, in addition, require that interlacing also be carried out at the viewing location since it is virtually impossible to synchronize or align oppositely polarized sheets with the appropriate portions of an image that has been broadcast or recorded in interlaced form.

It is not so much the lack of viable polarizers or polarizing filters that has limited the available of polarizing stereoscopic systems, but rather the lack of a practical arrangement for interlacing the images following polarization. This problem is solved in the present invention by either:

using microprism or lenticular sheets to combine side-by-side left and right eye images, or

by arranging the left and right eye images so that they can be combined using a simple optical combine or “beam splitter” without the need for additional optical devices other than the above-mentioned polarizers.

While it is believed that the use of microprism or lenticular sheets has never been attempted in the context of polarization-based stereoscopic viewing devices, the use of beam splitters to combine images has of course been known for centuries, and their use in the specific context of spatial image interlacing arrangements for stereoscopy, including image interlacing arrangements involving polarized images, has been disclosed in U.S. Pat. Nos. 5,671,992, 5,993,004, and 5,956,180. Nevertheless, prior stereoscopic viewing arrangements involving beam splitters and/or polarizers have proved to be no more practical than other types of prior stereoscopic viewing arrangements, either because the prior arrangements either fail to combine polarizers with a simple image interlacing arrangement, fail to take advantage of the polarizers in order to simply image separation following interlacing, and/or fail to recognize the importance of source geometry in minimizing the complexity of the optics required to orient the left and right eye images so that they can used in a practical stereoscopic device.

d. Temporal Interfacing

An alternative and heretofore more practical alternative to spatial interlacing is temporal interlacing, in which the left and right eye images are alternated, and the spatially interlaced images by either (i) viewing the display using shutter glasses in which the left and right eyes are alternately blocked in synchrony with the alternating images on the display, or (ii) alternately polarizing light from the display in synchrony with the alternating images on the display, and viewing the display through polarizing filters or lenses. In either case, problems because the scan rate is effectively halved, resulting in flicker, because it is in practice difficult to achieve instant shuttering (the most common method of shuttering is to energize a liquid crystal so that it is alternately opaque and transparent), and because the electronics required are complex and relatively expensive.

e. Conversion of Temporally Interlaced Images Into Side-By-Side Compressed Split Images for the Purpose of Eliminating Flicker in Shutter Systems

To solve the flicker problem inherent in a shutter system, it has been proposed to use a frame delay technique that at least superficially resembles that of the present invention in that alternate frames of a temporally interlaced (or time division multiplexed) image are delayed and displayed in side-by-side fashion with non-delayed frames. However, unlike the system of the present invention, the purpose of the side-by-side display is not to permit the images to be optically multiplexed and viewed through passive polarization devices, but rather to eliminate flicker resulting from the shuttering, allowing the alternate frames to persist long enough to effectively blend together.

Examples of this conventional frame delay/shuttering system are described at [http\\:www.]stereo3d.com and [http\\:www.]stereographics.com. Both examples use LCD screens arranged in subfields to eliminated flicker by relying on the persistence of the image on the screen which has been switched off, and involve squeezing the respective images top to bottom by a factor of two, the subfields then being scanned at twice the usual rate so that the left and right eye images can be shuttered at the usual rate.

As indicated above, one difference between this system and that of the present invention is that the claimed invention does not squeeze the displayed images, but rather scales them proportionally and crops the scaled images (or crops the images and then scales them proportionally) to fit side-by-side the display screen. This difference results from the entirely different purposes of the frame delays and side-by-side displays of the conventional system and the system of the invention, the conventional arrangement being for the purpose of eliminating flicker in shuttered stereoscopic systems, and the arrangement of the invention being simply to create a side-by-side display that can be optically multiplexed by a microprism or lenticular screen in the manner described in parent U.S. patent application Ser. No. 09/538,731.

f. U.S. patent application Ser. No. 09/538,731

The system and method disclosed in parent U.S. patent application Ser. No. 09/538,731 eliminates the need for any sort of shuttering, color filters, or other inconvenient or annoying devices. Essentially, the system and method relies on simultaneous display of the left and right images, interlacing of the images, and opposite polarization of images to be optically interlaced so that they can be viewed through passive polarizing lenses or filters. The present invention provides an improved arrangement for forming the simultaneously displayed left and right images, and in addition provides for interlacing of the images even when they are not displayed in side-by-side fashion, which is especially advantageous in the context of stereoscopic visor systems. Although the system and method described in U.S. patent application Ser. No. 09/538,731 specifically utilizes microprism or lenticular sheets to interlace side-by-side images, the present invention enables image interlacing to be accomplished by utilizing a beam splitter if the simultaneously displayed left and right eye images are appropriately arranged.

With respect to the image forming aspect of the present invention, it will be appreciated that there are numerous ways in which simultaneous display of left and right eye images could be achieved, and that the system and method disclosed in the parent application is in general not limited to a particular method or system for obtaining and displaying the left and right eye images. As pointed out in the parent application, the images may be split at the source or receiving end of a broadcast, and may be split along a horizontal or vertical line.

Nevertheless, the present invention involves a particularly advantageous ways to achieve simultaneous display of left and right images, either for side-by-side display and combination by a microprism or lenticular sheet, or for display in a manner that permits the convenient use of a beam splitter to combine the images. The advantage is that the present invention is compatible with shutter technology already in existence since the present system and method involves conversion into side-by-side images of time division multiplexed images that have also been formatted for use in a shuttering system. In addition, the system and method described in the present application may be useful for converting two-dimensional images into a pseudo stereoscopic image by splitting the image in the manner described below, or even an actual stereoscopic image if the alternate frames of the image are processed prior to display using proposed software that calculates an amount of rotation of the alternate frames necessary to achieve a true stereoscopic effect.

### SUMMARY OF THE INVENTION

It is accordingly a first objective of the invention to provide a practical way of separating a time division multiplexed image into pairs of simultaneously displayed images.

It is a second objective of the invention to provide a practical way of creating a simultaneous image display that may be used in connection with polarizers and a passive optical multiplexer or interlacing device, such as a microprism sheet, lenticular array, or beam splitter, to provide a stereoscopic imaging effect.

It is a third objective of the invention to provide a system and method of converting a time division multiplexed image consisting of alternating left and right eye images into a stereoscopic image without the need for shuttering of the left and right eye images.

It is a fourth objective of the invention to provide an imaging interlacing arrangement for combining simultaneously displayed images utilizing a beam splitter, that does not require complex optics, and which may be used to directly combine images displayed on one or more LCD screens.

It is a fifth objective of the invention to provide a stereoscopic image display system and method that is simple, economical, and convenient for the user.

These objectives are achieved, in accordance with the principles of various preferred embodiments of the invention, by providing a stereoscopic imaging system and method in which left and right eye images are alternately transmitted to a display device, processed using a frame delay circuit that crops, proportionally scales, and shifts alternate frames to simultaneously display the alternate frames, polarized following display, and combined following polarization.

As in the system and method of parent U.S. patent application Ser. No. 09/538,731, image interlacing is provided by an especially simple and effective arrangement involving a microprism or lenticular sheet having one set of surfaces oriented at a first angle corresponding to a position of a first image source, and a second set of surfaces oriented at a second angle corresponding to a position of a second image source so as to interlace the images. By appropriately selecting the position of the images to be interlaced, and therefore the first and second angles, the interlaced image can be made to project into a single plane. If the images are pre-polarized or otherwise differentiated before interlacing, the interlaced images can thus be directly combined to exhibit a three-dimensional stereoscopic effect when viewed directly through corresponding lenses.

The separate images combined or interlaced in the preferred stereoscopic imaging system and method of the invention may be displayed on a split screen, multiple screens arranged horizontally, multiple screens arranged vertically, and may even include images of real objects, as well as images displayed on cathode ray tubes, liquid crystals displays, or any other video or still image displays.

Advantageously, the system and method of the invention can be applied to a liquid crystal display suitable for use in a visor or virtual reality display device. The result is a stereoscopic device having a construction that is significantly simpler than the stereoscopic viewing devices or visors of the prior art, which relied on beam splitters or multiple polarizations. Such a stereoscopic device has potential application as a video game player, virtual reality display visor, stand-alone “3D” movie viewer, and so forth.

Furthermore, the simultaneously displayed images may be combined not only using a microprism or lenticular sheet, but also by means of a beam splitter, if the images are displayed at a ninety degree relative angle, rather than side-by-side. This arrangement is especially advantageous in the context of a visor, where space is at a premium, and has the advantage of keeping the light values of the two images constant.

While especially suitable for use in stereoscopic imaging systems or devices, and in particular those in which the left and right eye portions of a stereoscopic or three-dimensional image are distinguished by opposite polarization, it will be appreciated by those skilled in the art that the image splitting and image interlacing devices of the invention may be used in contexts other than those involving true stereoscopic images, including heads-up displays of various types, closed captioning, or other displays of superimposed images.

### BRIEF DESCRIPTION OF THE DRAWINGS

FIG. 1 is a schematic diagram of a prior art stereoscopic imaging arrangement.

FIG. 2 is a schematic diagram illustrating use of a microprism sheet to interlace images according to the principles of a first preferred embodiment of the invention.

FIG. 3 is a schematic diagram showing a handheld stereoscopic device constructed according to the principles of a second preferred embodiment of the invention.

FIG. 4 is a schematic diagram of an image interlacing arrangement according to a third preferred embodiment of the invention.

FIG. 5 is a schematic diagram of an image interlacing arrangement according to a fourth preferred embodiment of the invention.

FIG. 6 is a schematic diagram of an image interlacing arrangement according to a fifth preferred embodiment of the invention.

FIGS. 7A-7C are plan views of modifications of the microprism sheets shown in FIGS. 2-6.

FIG. 8 is a schematic block diagram of a circuit for displaying alternate frames of an image side-by-side which may be used in connection with the system and method of FIGS. 1-6.

FIGS. 9-12 are schematic circuit diagrams of possible implementations of the circuit illustrated in FIG. 8.

FIG. 13 is a diagram illustrating a processing sequence for the circuit illustrated in FIG. 12.

FIG. 14 is a schematic diagram of a variation of the split image stereoscopic device of the invention in which the microprism or lenticular image interlacing sheet is replaced by a beam splitter.

### DETAILED DESCRIPTION OF THE PREFERRED EMBODIMENTS

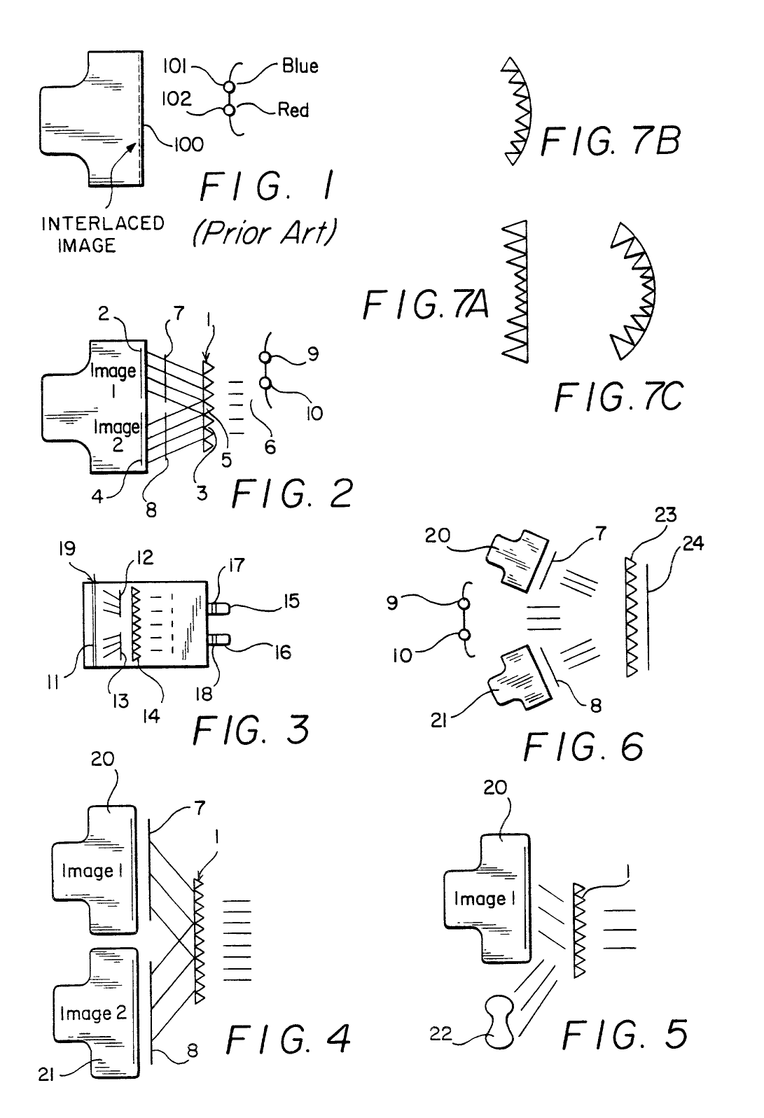

As illustrated in FIG. 2, a microprism sheet 1 is arranged such that light from a first image 2 is refracted by surfaces 3 and light from a second image 4 is refracted by surfaces 5 so as to exit the microprism sheet in parallel and thereby form a single interlaced image 6. The angles of surfaces 3 and 5 are selected based on the position of the microprism and on the relative positions of the separate images, which originate in this embodiment from a split screen divided vertically, horizontally, or in any other desired manner, so that the separate images, which may correspond to the above-described left eye and right eye images, can easily be polarized by polarizing filters or sheets 7,8 positioned between the image source and the microprism sheet before interlacing for viewing by appropriately polarized lenses 9,10 after interlacing.

It will be appreciated that the facets of the microprism sheet 1 illustrated in FIG. 2 are not drawn to scale. The construction of the microprism sheet may be entirely conventional, utilizing the known construction techniques and materials described in copending U.S. patent application Ser. No. 09/481,942, or the microprism sheet may be modified to include anti-glare, anti-radiation, or other coatings. In addition, according to the principles described in the copending application, the separate polarizers 7 and 8 may be replaced by polarizing coatings on individual facets of the microprism sheet 1, and the microprism sheet may be replaced by a lenticular sheet or honeycomb sheet similar to the ones described in copending U.S. patent application Ser. No. 09/592,913.

The simple image interlacing arrangement illustrated in FIG. 1 can easily be integrated into stereoscopic effects devices such as the one illustrated in FIG. 3. In this device, the image source is provided by an LCD screen 11, polarization by polarizing sheets 12,13, interlacing by microprism sheet 14, and direction of the appropriate image portions to the left and right eyes of the viewer by eyepieces 15,16 including polarized filters or lenses 17,18, all of which are contained in a housing 19. In addition, it is within the scope of the invention to provide additional optical components (not shown) for the purpose of focusing or guiding light between the illustrated components.

The stereoscopic effects device of this embodiment of the invention can be used as a portable or handheld video game player, or integrated into a variety of other devices such as arcade games, virtual reality visors, aircraft or military training simulators, and any other devices that currently use flat two-dimensional displays, but which might benefit from the addition of stereoscopic effects.

Instead of a single screen image source as illustrated in FIG. 2, the principles of the invention may be extended to cover images that originate on separate screens 20,21, as illustrated in FIG. 4, or arbitrary image sources 22 other than video screens, including real objects, as illustrated in FIG. 5. In addition, by placing a microprism sheet 23 having appropriately shaped facets in front of a mirror 24, or by adding a reflective coating to the back of the sheet, the image interlacing arrangement can possibly be arranged to form an image interlacing projection screen, as illustrated in FIG. 6.

As illustrated in FIGS. 7A-7C, the microprism sheets used to interlace the images in any of the embodiments of FIGS. 2-4 need not be planar microprism sheets with uniform facets. It is also within the scope of the invention to vary the size of the facets so as to focus or project images transmitted thereby, as illustrated in FIG. 7A, to curve the sheets to achieve similar effects, as illustrated in FIG. 7B, or to combine the concepts of varying the size of the facets and curving the sheets, as illustrated in FIG. 7C.

Although potentially useful in connection with image interlacing applications as described herein, the microprism sheet modifications illustrated in FIGS. 7A-7C may be used in any context in which microprism sheets are conventionally used, and possibly in additional contexts. For example, if the microprism sheet of FIG. 7B is formed in a parabola shape, the microprism sheet can be used as a convenient focusing lens or collimator.

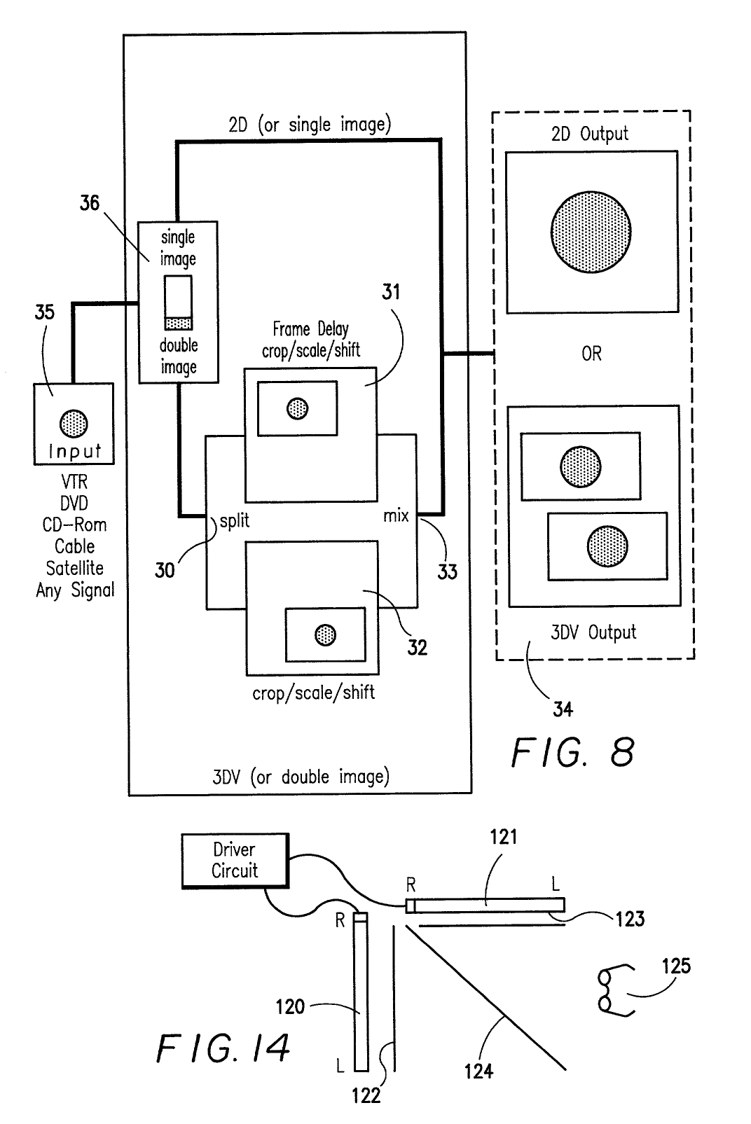

Those skilled in the art will appreciate that the split images to be combined by the microprism or lenticular sheets illustrated in FIGS. 1-6 and 7A-7C may be obtained by any convenient method, and that the invention in its broadest form is not to be limited to a particular system or method of creating the split image. However, FIGS. 8-10 illustrate an especially advantageous system and method for creating a split image, in which the split image is obtained from a time-division-multiplexed or interlaced-frame video image source.

In particular, as illustrated in FIG. 8, the system and method of this embodiment of the invention uses a frame delay processing circuit to demultiplex the alternating frames by using a switch 30 to direct every other frame to a time delayed or buffered processing circuit 31 (or simply splitting the image and only processing alternate frames of the two image streams), and then cropping, shifting, and proportionally scaling the delayed and real time image frames in delayed processing circuit 31 and real time processing circuit 32, before combining the images (mixer 33) for side-by-side display 34 in the manner also illustrated in FIGS. 1-6.

Those skilled in the art will appreciate that the term “proportionally scaling” refers to reducing the size of the image equally in all directions, as opposed to the 1:2 scaling of the shuttered stereoscopic systems described above. In addition, it will be appreciated that the cropping, scaling, and shifting processing steps may occur in any convenient order (i.e., scaling/cropping/shifting; scaling/shifting/cropping, etc.) without departing from the scope of the invention, that the input 35 may be any video source, including video tape, digital video disc or CD ROM, and cable, wireless, or satellite broadcasts, and that the circuits of the invention may be included in a television or display device including a switch 36 that permits bypass of the frame delay circuit by switching, either manually or based on a control signal, between two-dimensional and three dimensional display paths (or, alternatively, between single image and double image display paths).

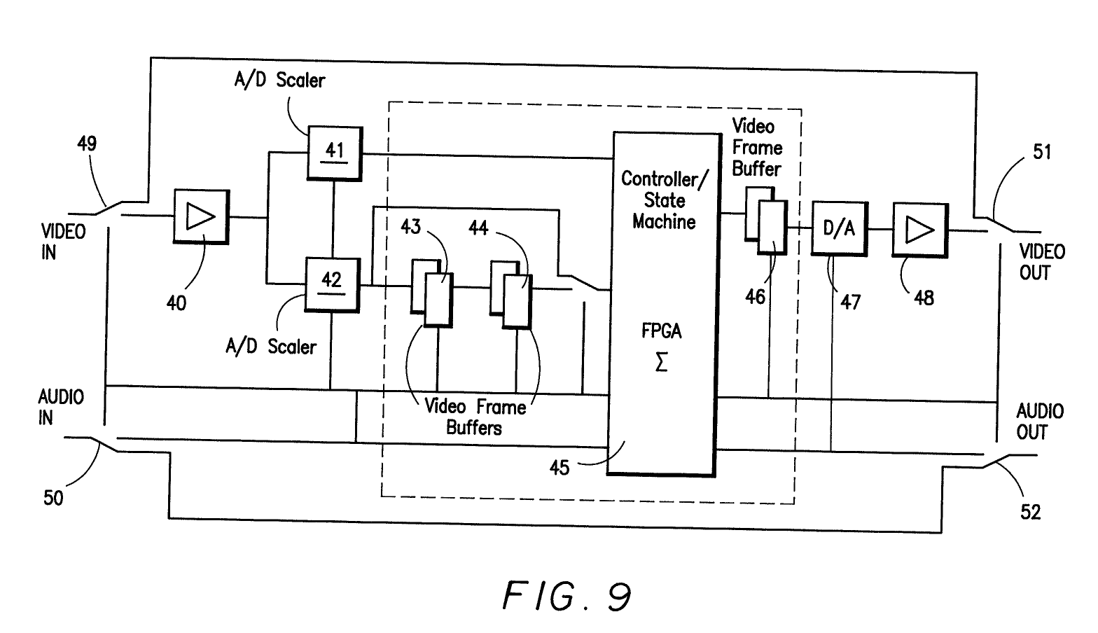

FIGS. 9, 10, 11, and 12 illustrate various possible implementations of the circuitry generally illustrated in FIG. 8. In the circuit illustrated in FIG. 9, alternate frames are input through amplifier 40 and scaling is performed by analog-to-digital (A/D) converters 41,42, the output of A/D/scaler 42 being buffered in buffers 43,44 before combination by field programmable gate array (FPGA) circuit 45 and output through frame buffer 46, digital-to-analog converter 47, and amplifier 48. FPGA circuit 44 is also used to process audio signals, and bypass switches 49-52 are provided for both video and audio, enabling display of single or two-dimensional images as well as split images.

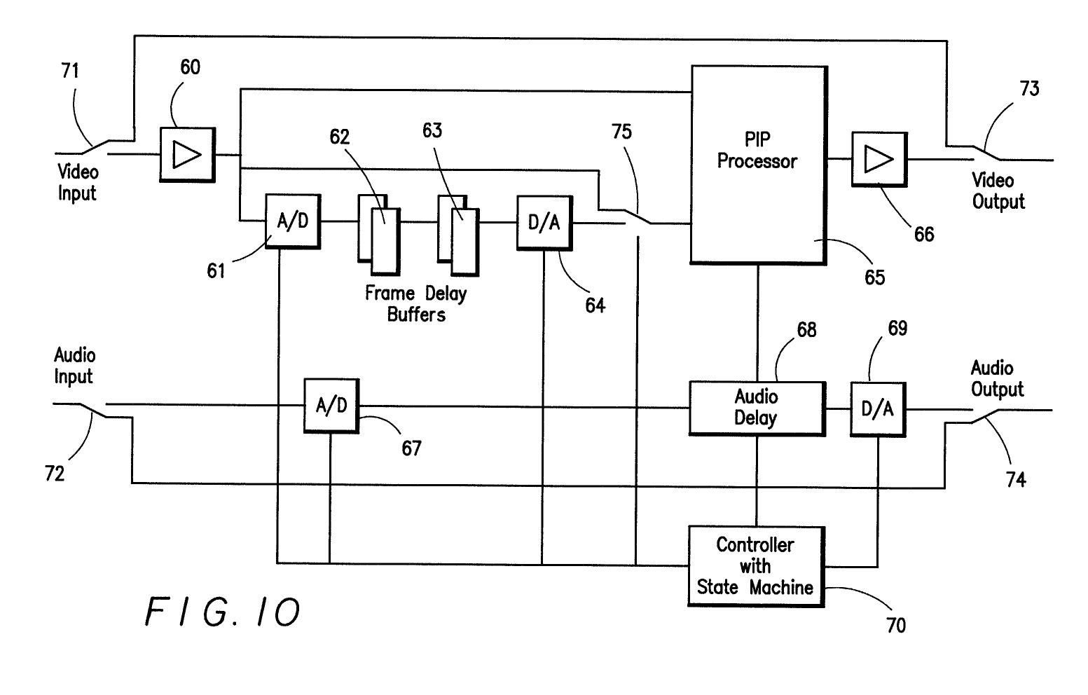

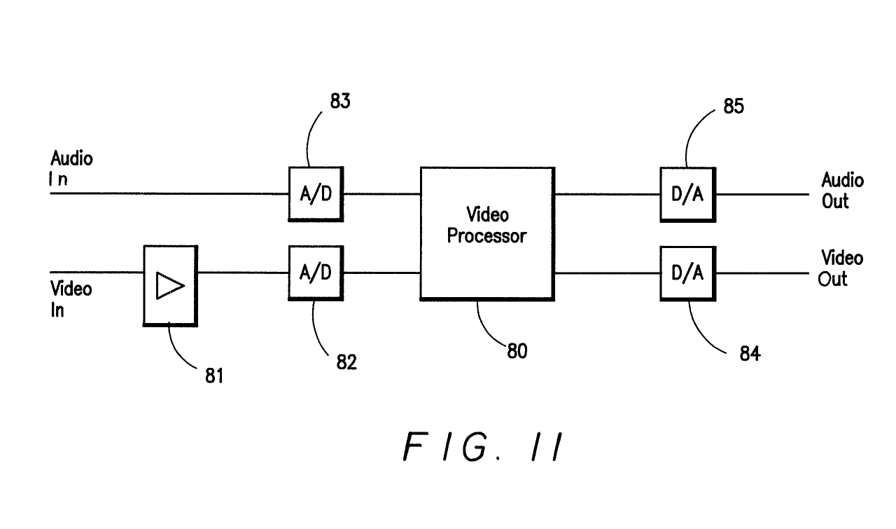

A second possible implementation, illustrated in FIG. 10, involves provision of a digital frame delay circuit including input buffer 60, A/D converter 61, frame delay buffers 62,63, and D/A converter 64 to provide a one frame delay of alternate frames, and to use analog picture-in-picture (PIP) processor 65 to scale, crop, shift, and combine the directly input and delayed images for output through buffer 66. In this implementation, an audio A/D converter 67, audio delay circuit 68, audio D/A converter 69 must also be provided, as well as a separate state machine/controller 70, single image video and audio bypass switches 71-74, and a bypass switch 75 for enabling normal single image picture-in-picture operation.

A third implementation, illustrated in FIG. 11, involves use a video processor 80 to perform all of the necessary time-delay, scaling, cropping, and shifting functions. According to this implementation, the only separate components required are video buffer 81, video and audio A/D converters 82,83, and video and audio D/A converters 84,85.

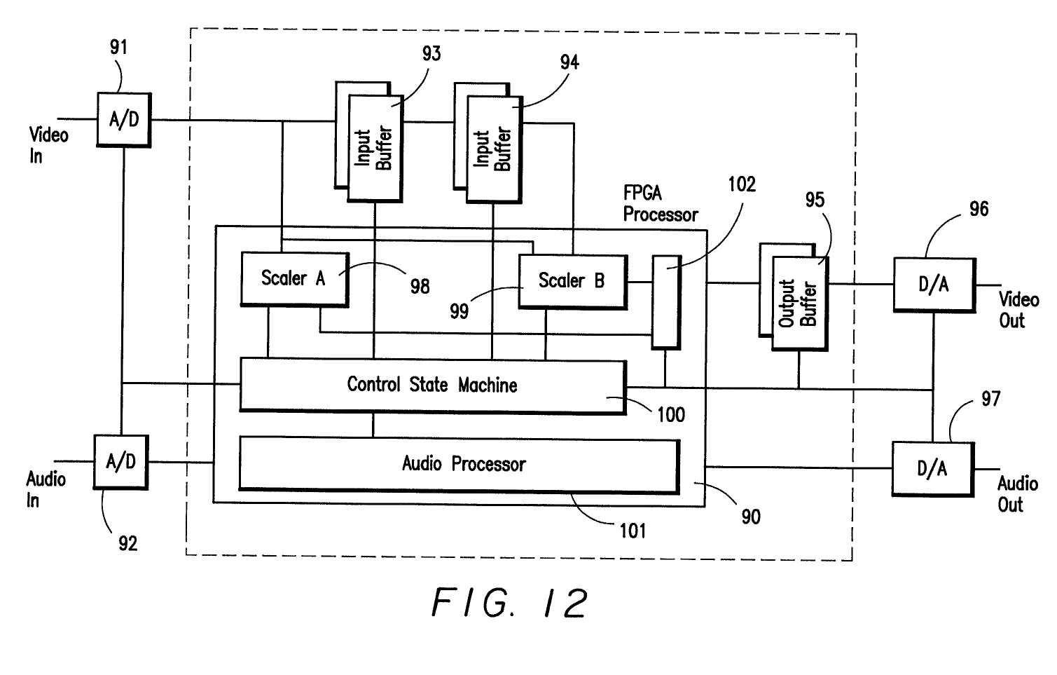

Finally, a fourth implementation, illustrated in FIG. 12, involves use an FPGA processor 90, video and audio D/A converters 91,92, frame delay video buffers 93,94, output buffer 95, and video and audio A/D converters 96,97. The FPGA circuit 90 includes scalers 98,99, a control state machine 100, audio processor 101, and combiner 102.

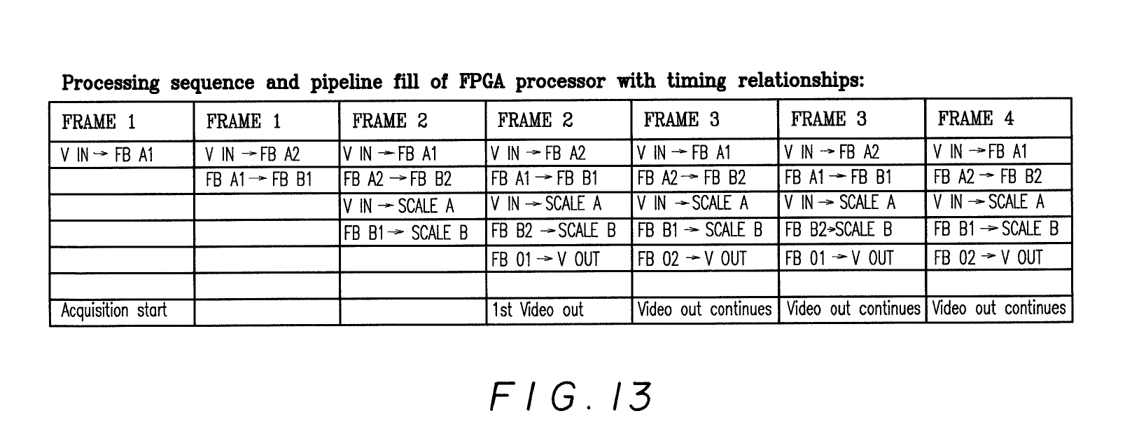

FIG. 13 depicts the processing sequence and pipeline fill of the FPGA processor 90 illustrated in FIG. 12, which is similar to the processing sequences for the implementations illustrated in FIGS. 9-11. V IN designates the video input signal, FB AX and FB BX, X=1,2 designates respective video frame buffers 93,94 for frames 1 and 2, F OX, X=1,2 designates output video buffer 95 for frames 1 and 2, and V OUT designates the video output signal. Upon start of acquisition, the input frame buffers 93,94 are filled with data until one full frame is recorded. At this point, the real time video input is scaled, cropped, and positioned in scaler A, while scaler B processes the data output by buffers 93,94. The outputs of scalers A and B are then deposited via gate 102 into output buffer 95.

Those skilled in the art will appreciate that in each of the specific implementations illustrated in FIGS. 9-13, any of the discrete components may be combined into integrated components, such as integrated circuits, and that each of the implementations depicted in FIGS. 9-13 is in any case intended to be illustrative in nature rather than limiting, the invention being intended to cover every possible implementation of the basic concept depicted in FIG. 8.

Turning now to the embodiment of FIG. 14, in which the microprism or lenticular sheets of the embodiments illustrated in FIGS. 1-6, are replaced by a beam splitter, two image sources 120,121 are oriented at a ninety degree angle relative to each other. In the case of a stereoscopic device, the images represent left and right eye images, which may be generated according to the circuitry illustrated in FIGS. 8-13. The left and right eye images are polarized by polarizers 122,123 and combined by beam splitter 14 for separation by polarized lenses in glasses 125.

The image sources in the arrangement illustrated in FIG. 14 may be separate LCDs or a flexible LCD that has been folded to a ninety degree angle. In either case, use of the frame delay technique permits the LCDs to be controlled by a single driver, which makes the arrangement especially suitable for use in a visor.

One complication in this arrangement is that the image on the reflected image source 121 must be mirror symmetric with respect to the image on the original image source 122, as indicated by reference letters L and R in FIG. 14, which indicate the left and right sides of the image as viewed through glasses 125. This can easily be achieved electronically by flipping one of the images electronically during the crop/scale/shift processing step illustrated in FIG. 8 or, in the case of an LCD source, reversing the leads on image source 121 so that the left side of the original image is displayed on the right side of the source 121, and the right side is displayed on the left. Alternatively, it may be possible to physically flip over the LCD screen so that the image is viewed from what would ordinarily be the back side of the screen. Reversal of one of the images is of course required whether the image sources are separate LCDs, a folded LCD, or other types of image sources such as CRTs, and is also required for combinations of different types of image sources.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

What is claimed is:

1. An imaging system, comprising:
circuitry for separating a video input into two separate images;
a display arranged to simultaneously display the separate images;
polarizers arranged to oppositely polarize the separate images;
an image interlacing arrangement for combining the oppositely polarized separate images; and
polarizing filters for enabling respective right and left eyes of a person to view the corresponding oppositely polarized and interlaced separate images.

2. An imaging system as claimed in claimed in claim 1, wherein said separate images are stereoscopic left and right eye images.

3. An imaging system as claimed in claim 1, wherein said circuitry includes a frame delay circuit for separating the stereoscopic left and right eye images by electronically delaying alternate frames of the video input, and then cropping, scaling, and shifting the frame delayed images for simultaneous display.

4. An imaging system as claimed in claim 1, wherein the image interlacing arrangement includes:
a microprism sheet including a substrate and a plurality of grooves having intersecting sides that form a v-shape, the sides of the grooves forming first and second sets of substantially planar surfaces,
wherein said sides of the grooves are respectively arranged to refract light from first and second image sources so that said light from said first and second image sources exits said microprism sheet in parallel to form an interlaced image.

5. An imaging system as claimed in claim 1, wherein said separate images are displayed on image sources situated at an angle of ninety degrees relative to each other, and wherein said image interlacing arrangement includes a beam splitter situated at a forty five degree angle relative to each of the image sources.

6. An imaging system as claimed in claim 5, wherein said image sources consist of two separate LCD screens.

7. An imaging system as claimed in claim 5, wherein said image sources consist of separate portions of a single flexible LCD screen that has been folded to a ninety degree angle.

8. An imaging system as claimed in claim 5, wherein one of the two image sources is mirror symmetric relative to the other of the two image sources.

9. An imaging system as claimed in claim 5, wherein said circuitry for separating the video input into two separate images comprises circuitry for generating a mirror image of one of the two separate images.

10. An imaging system as claimed in claim 1, wherein said images are displayed on separate regions of a single image display screen.

11. An imaging system as claimed in claim 10, wherein said single image display screen is an LCD screen.

12. An imaging system as claimed in claim 1, wherein said separate images are displayed on separate image display screens.

13. Circuitry for separating a video input into two separate images, comprising:
a frame delay circuit for separating images included in alternating frames of a time division multiplexed video input by electronically delaying the alternate frames of the video input, and then cropping, proportionally scaling, and shifting the frame delayed images for simultaneous display.

14. Circuitry as claimed in claim 13, wherein said separate images are stereoscopic left and right eye images.

15. An imaging method, comprising the steps of:
separating a video input into separate images;
simultaneously displaying the separate images on a screen;
oppositely polarizing the simultaneously displayed separate images;
interlacing the oppositely polarized separate images; and
viewing the oppositely polarized and interlaced separate images through polarizing filters.

16. An imaging method as claimed in claim 15, wherein the separate images are stereoscopic left and right images.

17. An imaging method as claimed in claim 15, wherein the step of separating the video input into separate images comprises the steps of:
storing a first image frame in a buffer;
receiving a second image frame;
proportionally scaling said first and second image frames;
cropping said proportionally scaled image frames to fit on opposite halves of said screen;
shifting said cropped and proportionally scaled image to be located in said opposite halves of the screen;
combining said scaled, cropped, and shifted images.

18. An imaging method as claimed in claim 15,
wherein the step of combining the images comprises the step of interlacing the images using an image interlacing arrangement that includes:
a microprism sheet including a substrate and a plurality of grooves having intersecting sides that form a v-shape, the sides of the grooves forming first and second sets of substantially planar surfaces,
wherein said sides of the grooves are respectively arranged to refract light from first and second image sources so that said light from said first and second image sources exits said microprism sheet in parallel to form an interlaced image.

19. An imaging method as claimed in claim 15, wherein the step of interlacing the oppositely polarized separate images comprises the steps of orienting said image sources at an angle of ninety degrees relative to each other, generating a mirror symmetric version of one of the two separate images, and using a beam splitter situated at a forty five degree angle relative to each of the image sources to interlace the mirror symmetric version with the other of the two separate images.

20. A method of separating a video input into simultaneously displayed images, comprising the steps of:
storing a first image frame in a buffer;
receiving a second image frame;
proportionally scaling said first and second image frames;
cropping said proportionally scaled image frames to fit on opposite halves of said screen;
shifting said cropped and proportionally scaled image to be located in said opposite halves of the screen;
combining said scaled, cropped, and shifted images.

21. An imaging method as claimed in claim 20, wherein the separate images are stereoscopic left and right images.
